(19) United States
(12) Patent Application Publication
(10) Pub. No.: US 2018/0275399 A1
(43) Pub. Date: Sep. 27, 2018

(54) HEAD MOUNTED DISPLAY WITH DEPTH FOCUS ADJUSTMENT

(71) Applicant: INTEL CORPORATION, SANTA CLARA, CA (US)

(72) Inventors: DANIEL ZHANG, HILLSBORO, OR (US); RAMON CANCEL OLMO, HILLSBORO, OR (US); RICHMOND HICKS, ALOHA, OR (US)

(73) Assignee: INTEL CORPORATION, SANTA CLARA, CA (US)

(21) Appl. No.: 15/465,529

(22) Filed: Mar. 21, 2017

(51) Int. Cl. G02B 27/00; G02B 27/22; G02B 27/01; G06T 5/00

(52) U.S. Cl. CPC G02B 27/0075; G02B 27/2228; G02B 2027/0127; G06T 5/002; G02B 2027/0134; G02B 27/0172

(57) ABSTRACT

A head-mounted display (HMD) with depth focus adjustment includes an optical assembly to enable a viewer to view a stereoscopic image display on a display element. The optical assembly includes at least one optical element and has an adjustable depth of focus. A control signal may be generated to cause the optical assembly to adjust the depth of focus of the optical assembly to be in one of two different viewing modes having different depths of focus.

### TECHNICAL FIELD

Embodiments herein generally relate to head mounted displays (HMDs) and head worn displays (HWDs), and particularly relate to a head mounted display with depth focus adjustment.

### BACKGROUND

Modern display technology may be implemented to provide head mounted displays (HMDs) which enable immersive, virtual reality (VR) experiences, for example. A factor in the immersive, VR experience is presentation of visual information in a realistic manner, e.g., providing the information in 3D. Conventional HMD systems for 3D imagery use binocular (stereoscopic) displays to deliver stereoscopic images to the user to create the 3D images, and the conventional HMDs' optical lenses are not adjustable in terms of depth of focus, which leads to eye discomfort when a user tries to switch focus between objects at different virtual distances.

### BRIEF DESCRIPTION OF THE DRAWINGS

FIGS. 1a-1c illustrate examples of stereo displays as viewed by a user.

FIG. 2 illustrates a head mounted display (HMD) according to an embodiment.

FIG. 3a illustrates convergence and accommodation of eyes.

FIG. 3b illustrates different viewing modes of a HMD.

FIG. 4 illustrates different viewing modes of an optical subassembly according to an embodiment.

FIG. 5 illustrates different viewing modes of an optical subassembly according to another embodiment.

FIG. 6 illustrates a block diagram of an embodiment of a control system.

FIG. 7 illustrates an example first logic flow.

FIG. 8 illustrates an example second logic flow.

FIG. 9 illustrates an example computer readable medium.

FIG. 10 illustrates an embodiment of a system.

FIG. 11 illustrates an embodiment of a computing architecture.

FIG. 12 illustrates an embodiment of a communications device.

### DETAILED DESCRIPTION

Various embodiments may be generally directed to head mounted displays (HMDs) and specifically directed to a head mounted display with depth focus adjustment, which significantly improves the user experience.

HMDs for 3D imagery using binocular displays may include one or more display surface(s) and a viewing lens system mounted to a housing. During operation, a left-eye image and a right-eye image are generated on the display surface(s) and are viewed through a left-eye lens and a right-eye lens, respectively, to achieve a stereoscopic 3D imagery. Stereoscopic displays, however, provide some inaccurate cues regarding depth information, which leads to conflicts within the visual system, which in turn leads to eye stress and discomfort. Because conventional HMDs' optical lenses are not adjustable in terms of depth of focus, eye stress and discomfort caused when a user tries to switch focus between objects at different virtual distances are not remedied.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, known structures and devices are shown in block diagram form in order to facilitate a description thereof. The intention is to provide a thorough description such that all modifications, equivalents, and alternatives within the scope of the claims are sufficiently described.

Additionally, reference may be made to variables, such as, “a”, “b”, “c”, which are used to denote components where more than one component may be implemented. It is important to note, that there need not necessarily be multiple components and further, where multiple components are implemented, they need not be identical. Instead, use of variables to reference components in the figures is done for convenience and clarity of presentation.

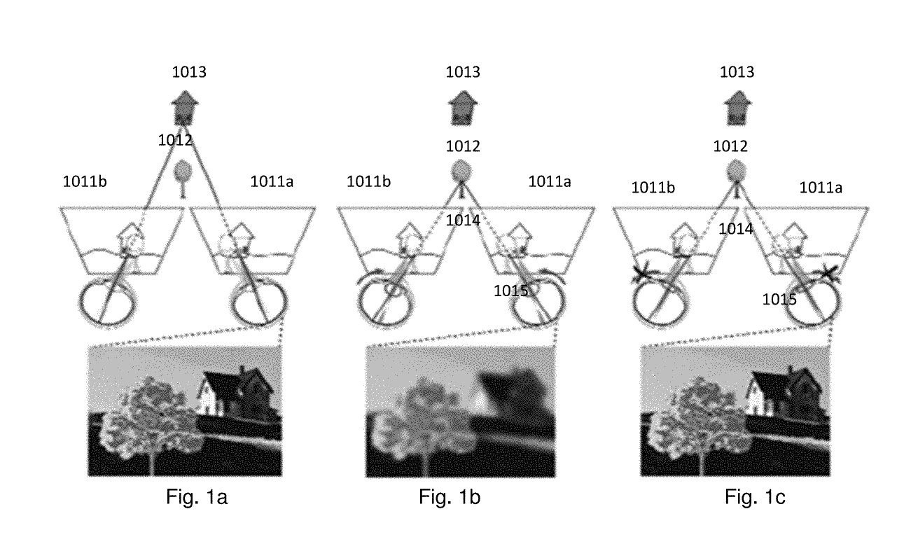

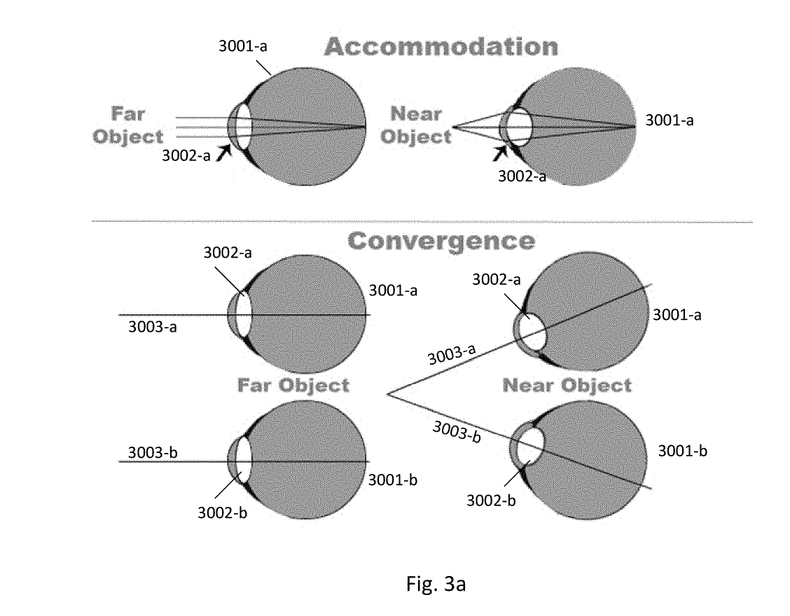

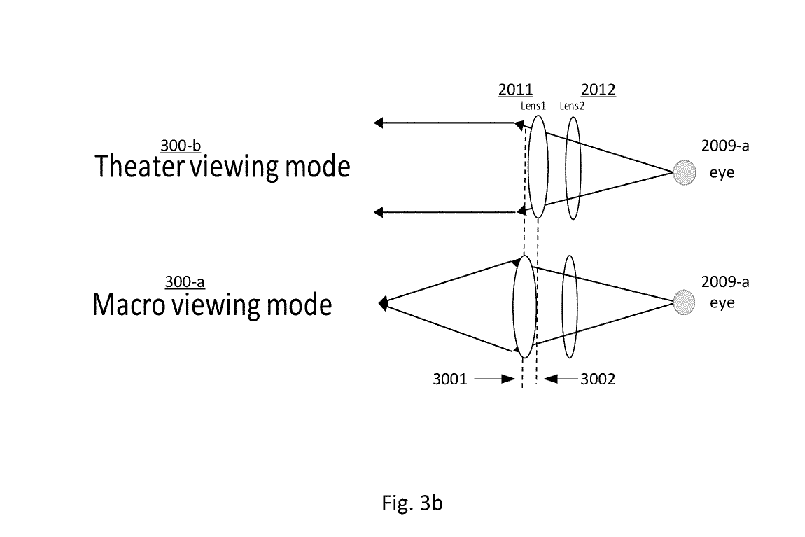

The relationship between the stereoscopic cues and the eye stress and discomfort is illustrated in connection with FIGS. 1a-1c, which illustrate examples of stereo displays as viewed by a user, and in connection with FIG. 3a, which illustrates phenomena called “accommodation” and “convergence.” The top portion of FIG. 3a illustrates “accommodation.” To focus on nearby objects (the right diagram shown at the top portion of FIG. 3a), the ciliary muscle in the eye (e.g., a right eye 3001-a shown at the top portion of FIG. 3a) contracts, allowing the lens 3002-a (the white portion of the eye as shown at the top portion of FIG. 3a) to assume a more spherical shape in comparison to the shape of the lens 3002-a when the eye is focusing on far objects (the left diagram shown at the top portion of FIG. 3a). This process is called accommodation. The contraction and relaxation of the ciliary muscles also provides information about the depth.

The bottom portion of FIG. 3a illustrates “convergence.” When an object is very near to a viewer (the right diagram shown at the bottom portion of FIG. 3a), the eyes (e.g., right eye 3001-a and left eye 3001-b) converge (as shown by right and left lines of sight 3003-a and 3000b, respectively) to fixate on the object. As the object moves further away, the eyes diverge to maintain fixation. This process is called convergence. Feedback from the eye muscles that initiate these convergence movements provide some information about the object's distance from the observer. It should be noted that the bottom portion of FIG. 3a additionally shows the right and left eye lenses 3002-a and 3002-b, respectively, undergoing accommodation. Because accommodation and convergence processes need to act in unison when viewing real-world objects, human brain is hardwired to automatically link these operations, e.g., one process automatically triggers the other process.

Examples of stereo displays as viewed by a user will now be explained in connection with FIGS. 1a-1c. Because both the left-eye image and the right-eye image of a stereoscopic display are generated by flat 2-D display elements, e.g., liquid-crystal-display (LCD) panels, the optical viewing distance to each pixel of the image is the same, the distance to the screen. However, this visual cue conflicts with the cue provided by the stereoscopic information. The visual cues provided by the stereoscopic information is that some objects are at depths different from the display elements, e.g., in front of or behind the display elements, but the visual cue provided by the uniform optical viewing distance is that all of the objects are at the same distance, which causes accommodation to focus the eye to the optical distance of the screen. When the viewed object is positioned at the optical distance of the display element, accommodation and convergence match, e.g., the eyes can converge and focus to matching distances, resulting in a sharp image of the object. This is shown in FIG. 1a. It should be noted that there is only one correct distance for accommodation when viewing conventional stereoscopic displays. In other words, despite the fact that the stereoscopic cue places the tree 1012 and the house 1013 at different stereoscopic distances as shown in the right stereo image 1011a and left stereo image 1011b, both the tree and the house will be in focus if the eyes' accommodation is to the optical distance of the display element. In this case, the retinal blur is incorrect with respect to the stereoscopic information regarding the distances to the tree 1012 and the house 1013 as shown the stereo images 1011a and 1011b in FIG. 1a, e.g., the tree 1012 in the foreground according to the stereoscopic information should be blurry.

As shown in FIG. 1b, when eyes converge on a new object (e.g., tree 1012), the convergence causes accommodation to reflexively follow, resulting in the stereo display to be uniformly blurry. Because objects (tree 1012 and house 1013) that are positioned stereoscopically behind the display elements (e.g., 1011a and 1011b) require the eyes to point behind the screen while focusing at the distance of the display elements, in order to bring the stereo display back into focus, viewer must attempt to unnaturally decouple the linked processes of accommodation and convergence by keeping accommodation 1015 (represented by the eye lens size) fixed at the optical distance of the display element while adjusting the convergence 1014 to the distance of the tree, as shown in FIG. 1c, which causes eye stress and discomfort.

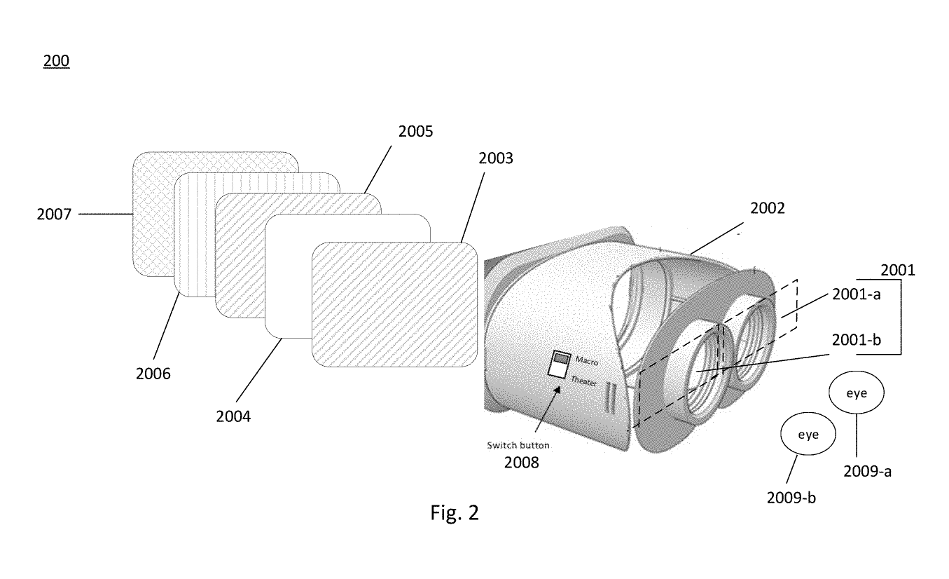

FIG. 2 illustrates an example of a head mounted display (HMD) device 200 arranged according to the present disclosure. It is noted, that the HMD device 200 of FIG. 2 is depicted as a binocular-shaped device. However, with some examples, the device 200 may be embodied as a pair of glasses, as goggles, as a helmet, as a visor, as a wearable device, or the like. Embodiments are not limited in this context.

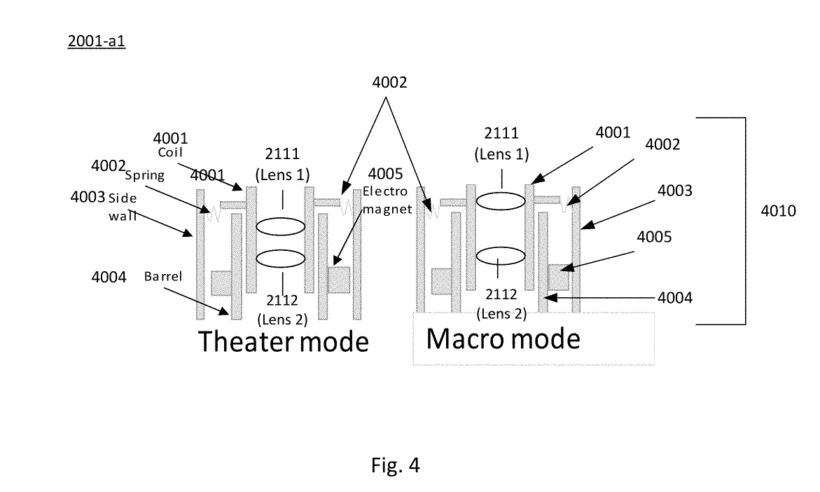

In general, the device 200 is configured to provide a virtual display. In some examples, the device 200 may provide a virtual display in conjunction with a real world view. The device 200 includes a housing 2002, to which an optical assembly 2001 (which includes a pair of optical subassemblies 2001-a (for a viewer's eye 2009-a) and 2001-b (for a viewer's eye 2009-b)), as well as other components of the device 200, are attached. The optical subassemblies 2001-a and 2001-b are shown schematically as dotted boxes in FIG. 2, and the details of optical subassemblies 2001-a and 2001-b are explained in connection with FIGS. 4-6. The device 200 may also include at least one display element having a display surface, e.g., a first liquid crystal display (LCD) 2003 having a display surface and a second liquid crystal display (LCD) 2005 having a display surface, as well as a spacer 2004. The device 200 may also include a projector, e.g., a backlight 2006, as well as driver electronics 2007 for controlling the image display on the display surface of the at least one display element, e.g., on the display surface of the first liquid crystal display (LCD) 2003 and/or on the display surface of the second liquid crystal display (LCD) 2005, and a control switch button 2008 for switching between different viewing modes of the optical subassemblies 2001-a and 2001-b. In an example embodiment, the displayed image on the display surface of the at least one display element may be a stereoscopic image formed by a right-eye image and left-eye image.

Although a physical switch button 2008 on the HMD 200 is shown as the switching control element in FIG. 2, switching between different viewing modes of the optical subassemblies 2001-a and 2001-b may also be performed by a switching signal transmitted either wirelessly or via a hardwire connection from a switching element which is separate from the HMD 200. In addition, although LCDs 2003 and 2005 along with backlight 2006 are shown in FIG. 2, other display elements may be utilized, e.g., light-emitting diode (LED) display, organic light-emitting diode (OLED) display, etc. Furthermore, although two separate display elements (e.g., LCDs 2003 and 2005) are shown, a single display element may be utilized. Embodiments are not limited in this context.

FIG. 3b illustrates two different viewing modes of a HMD using an optical subassembly 2001-a1 shown in FIG. 4, which optical subassembly 2001-a1 represents an embodiment of optical subassembly 2001-a shown in FIG. 2. Although only a single optical subassembly, e.g., optical subassembly 2001-a1, is shown in FIG. 4, the details of the optical subassembly 2001-a1 are equally applicable to both optical subassemblies 2001-a and 2001-b shown in FIG. 2. The optical subassembly 2001-a1 shown in FIG. 4 incorporates lenses 2011 and 2012 attached to a voice coil motor (VCM) 4010. The VCM 4010 may include the following components, for example: coil 4001, to which the lenses 2011 and 2012 are attached; a side wall 4003 and springs 4002 which connect the side wall 4003 to the coil 4001; a barrel 4004 and an electromagnet 4005 positioned on the barrel. The coil 4001 is operatively coupled to the barrel 4004 and the electromagnet 4005, as explained below.

The voice coil motor (VCM) 4010 shown in FIG. 4 utilizes electromagnetic forces to displace the lenses. When a current passes through the coil 4001, a magnetic field is produced, which magnetic field reacts with the electromagnet 4005 to displace the coil 4001. In the embodiment shown FIG. 4, the displacement of the coil 4001 is restricted by the barrel 4004 which encases the coil 4001, such that the coil 4001 is displaced only along the elongated axis of the barrel 4004. The springs 4002 attached to the coil 4001 restore the coil back to the rest, e.g., default, position once the current flow through the coil 4001 stops.

As shown in FIG. 4, because both lenses 2111 and 2112 are attached to the coil, when the coil is displaced, e.g., contracted, the lenses 2111 and 2112 are similarly displaced so that the spacing between the lenses 2111 and 2112 is changed. In the macro viewing mode (near distance viewing mode), which is the default position in the embodiment shown in FIG. 4, the lenses 2111 and 2112 are farther apart, as shown in FIG. 4 and as shown in the corresponding lens diagram 300-a in FIG. 3b. The default position (macro viewing mode position) of lens 2111 is indicated by the dotted line 3001. For the theater viewing mode (far distance viewing mode), the lenses 2111 and 2112 are brought closer together in comparison to the default position, as shown in FIG. 4 and as shown in the corresponding lens diagram 300-b in FIG. 3b, which s), which displacement of the lenses is achieved by a current flow through the coil 4001, which current flow in turn contracts the coil 4001. The theater viewing mode position of lens 2111 is indicated by the dotted line 3002. When the current flow through the coil 4001 stops, the spacing between the lenses 2011 and 2012 returns to the default position (macro viewing mode). Although only two viewing modes (near distance and far distance) are illustrated in FIGS. 3b and 4 for the sake of clarity, other viewing modes (e.g., intermediate distances) may be provided. Examples are not limited in this context.

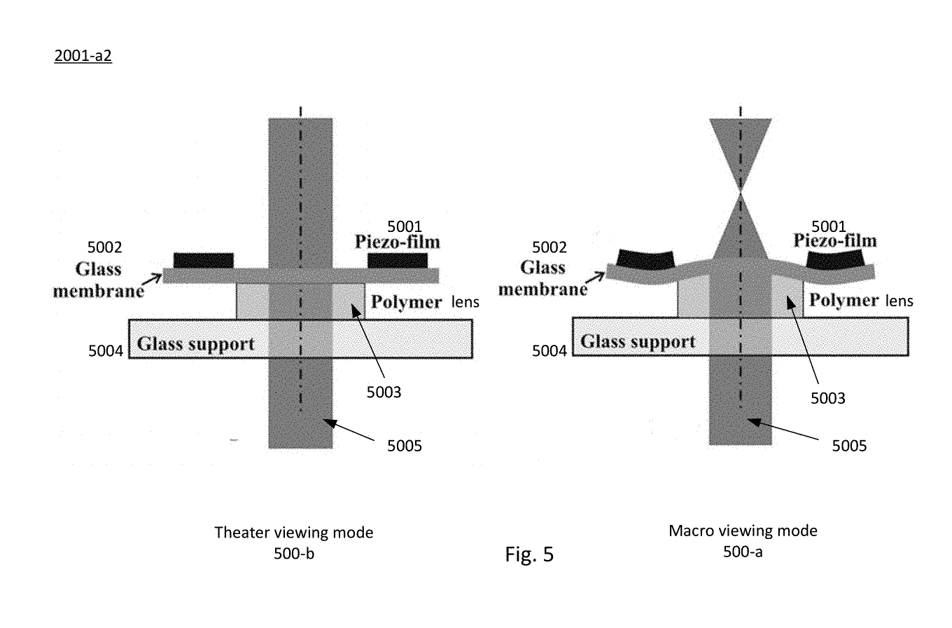

FIG. 5 illustrates two different viewing modes of a HMD using an optical subassembly 2001-a2 represents an embodiment of optical subassembly 2001-a shown in FIG. 2. Although only a single optical subassembly 2001-a2 is shown in FIG. 5, the details of the optical subassembly 2001-a2 are equally applicable to both optical subassemblies 2001-a and 2001-b shown in FIG. 2. The optical subassembly 2001-a2 shown in FIG. 5 includes a glass support substrate 5004, a deformable polymer layer 5003 provided on the glass support substrate 5004, a deformable glass membrane 5002 provided on the deformable polymer layer 5003, and a piezo-film 5001 provided on the glass membrane 5002. Upon application of a voltage, the piezo-film 5001, which acts as an actuator layer, is deformed, which in turn deforms the glass membrane 5002 and the polymer layer 5003, which acts as a lens (hence the designation “polymer lens” in FIG. 5). In this manner, the deformation of the polymer layer 5003 varies the optical focus. The left diagram of FIG. 5 shows the theater viewing mode 500-b, in which no voltage is applied to the piezo-film 5001, and the polymer layer 5003 provides an optical focus at a far distance (as represented by the light ray 5005). The right diagram shows the macro viewing mode 500-b, in which a selected voltage (e.g., up to 30V) is applied to the piezo-film 5001, and the polymer layer 5003 provides an optical focus at a near distance (as represented by the light ray 5005). Although only two viewing modes (near distance and far distance) are illustrated in FIG. 5 for the sake of clarity, other viewing modes (e.g., intermediate distances) may be provided. Examples are not limited in this context.

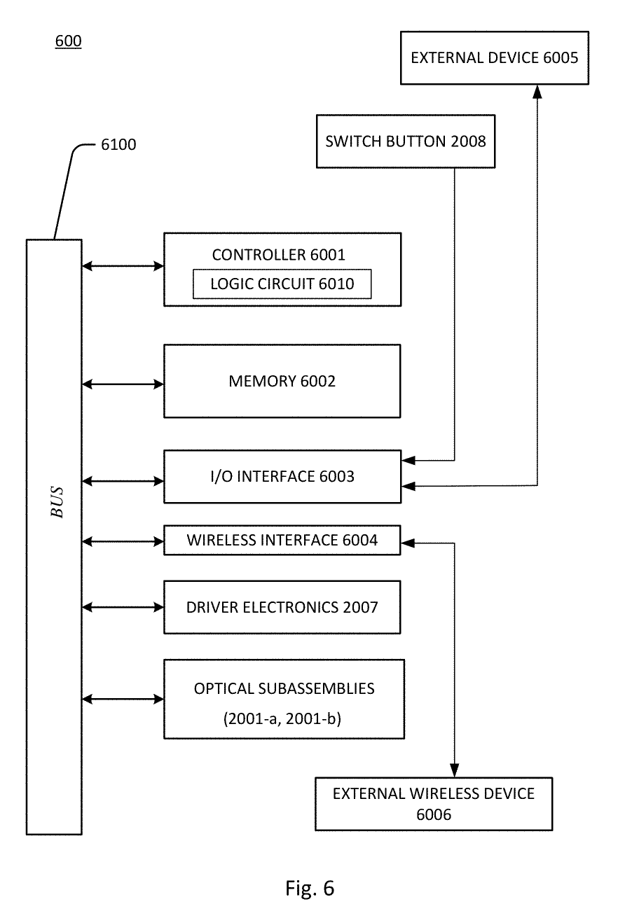

FIG. 6 shows a block diagram of a control architecture 600 according to an embodiment. The control architecture 600 may be utilized to control, for example, the operation of the optical subassemblies 2001-a and 2001-b. In addition, the control architecture 600 may be utilized to control other components of the HMD 200, e.g., the driver electronics 2007. According to the control architecture 600, a controller 6001 having a logic circuit 6010 is in communication with various other elements via the bus 6100, which elements include, for example: a memory 6002; input/output (I/O) interface 6003; a wireless interface 6004; driver electronics 2007; and optical subassemblies 2001-a and 2001-b. The I/O interface 6003 is in communication with the switch button 2008 and an external device 6005. In addition, the wireless interface 6004 is in communication with an external wireless device 6006.

The controller 6001 controls the operation of the optical subassemblies 2001-a and 2001-b as discussed above in connection with FIGS. 3b, 4 and 5, based on the selection of the viewing mode of the HMD 200, e.g., macro viewing (near distance) or theater viewing (far distance). The selection of the viewing mode may be based, for example, on the display content, e.g., whether the display content is optimized for the macro viewing mode or the theater viewing mode. The selection of the viewing mode may be achieved by an input via the switch button 2008. For the input selection, the user may be provided with cues regarding available viewing modes and/or the viewing mode for which the display content is optimized, for example. In addition, or alternatively, the selection of the viewing mode may be achieved by an input from the external device 6005, e.g., a computer. In addition, or alternatively, the selection of the viewing mode may be achieved by an input from the external wireless device 6006, e.g., a mobile phone or an electronic tablet device. In addition, or alternatively, the selection of the viewing mode may be achieved automatically by the controller 6001 which generates a selection control signal based on the determination of whether the display content is optimized for the macro viewing mode or the theater viewing mode.

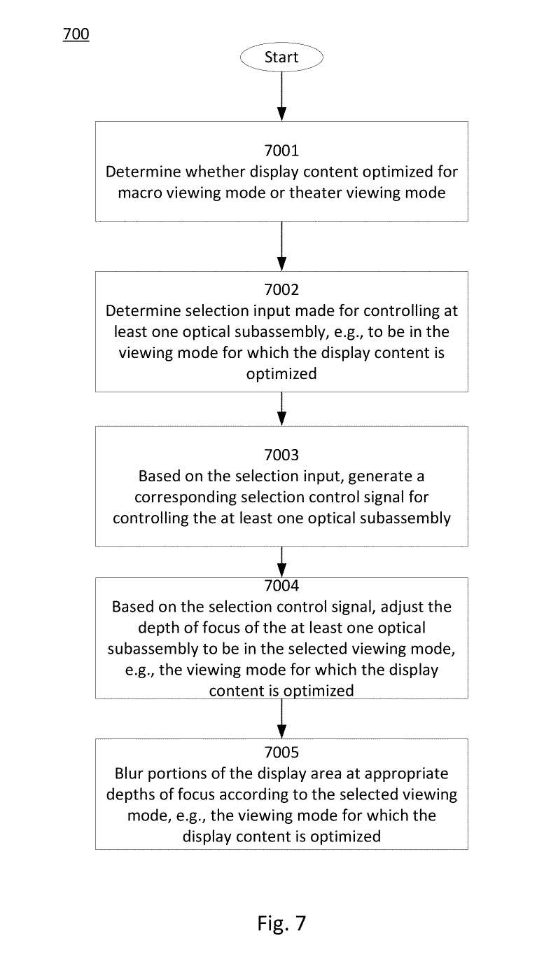

FIG. 7 depicts a logic flow 700 for adjusting the viewing mode of the HMD 200. The logic flow 700 may begin at block 7001. At block 7001, the controller 6001 may determine whether the display content is optimized for the macro viewing mode (near distance), the theater viewing mode (far distance), or some other modes (e.g., intermediate distances). Based on whether the display content is optimized for the macro viewing mode, the theater viewing mode, or another mode, a selection input may be made for controlling at least one optical subassembly (e.g., subassembly 2001-a and/or subassembly 2001-b) of the HMD 200, e.g., to be in the viewing mode for which the display content is optimized, which selection input may be achieved by an input from the user of the HMD, e.g., via the switch button 2008, the external device 6005, or the external wireless device 6006. At block 7002, the selection input made, e.g., by the user of the HMD 200, for controlling at least one optical subassembly (e.g., subassembly 2001-a and/or subassembly 2001-b) of the HMD 200, e.g., to be in the viewing mode for which the display content is optimized, is determined, e.g., by the controller 6001.

At block 7003, based on the selection input, a corresponding selection control signal for controlling the at least one optical subassembly is generated, e.g., by the controller 6001. At block 7004, based on the selection control signal, the depth of focus of the at least one optical subassembly (e.g., subassembly 2001-a and/or subassembly 2001-b) of the HMD 200 is adjusted to be in the selected viewing mode, e.g., the viewing mode for which the display content is optimized. At block 7005, portions of the display area are blurred, e.g., by control of the driver electronics 2007 based on a control signal from the controller 6001, at appropriate depths of focus according to the selected viewing mode, e.g., the viewing mode for which the display content is optimized. The blurring of the portions of the display area according to the selected viewing mode mimics the optical cues for the eyes provided when viewing real 3D objects, thereby allowing the viewer to see the stereo display in focus without unnaturally decoupling the linked processes of accommodation and convergence.

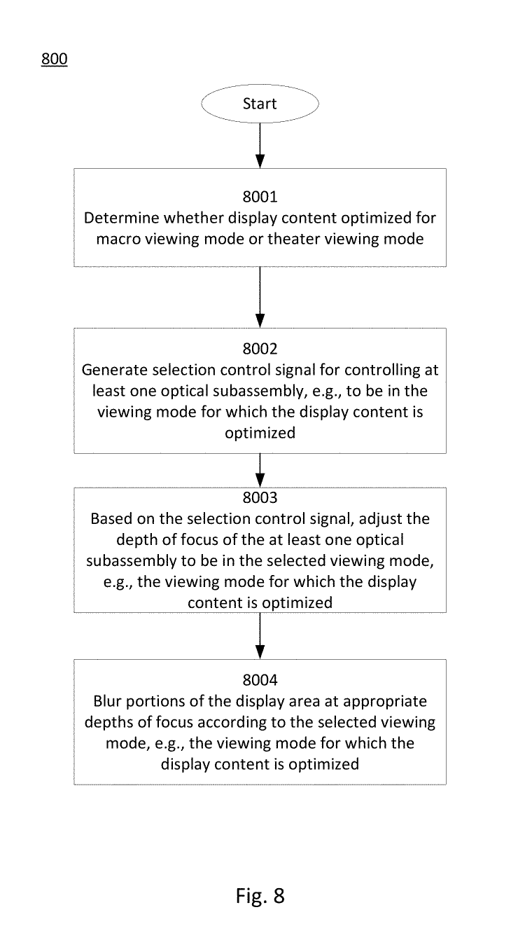

FIG. 8 depicts a logic flow 800 for adjusting the viewing mode of the HMD 200. The logic flow 800 may begin at block 8001. At block 8001, the controller 6001 may determine whether the display content is optimized for the macro viewing mode (near distance) or the theater viewing mode (far distance). At block 8002, based on whether the display content is optimized for the macro viewing mode or the theater viewing mode, a selection control signal may be generated, e.g., by the controller 6001, for controlling at least one optical subassembly (e.g., subassembly 2001-a and/or subassembly 2001-b) of the HMD 200, e.g., to be in the viewing mode for which the display content is optimized.

At block 8003, based on the selection control signal, the depth of focus of the at least one optical subassembly (e.g., subassembly 2001-a and/or subassembly 2001-b) of the HMD 200 is adjusted to be in the selected viewing mode, e.g., the viewing mode for which the display content is optimized. At block 8004, portions of the display area are blurred, e.g., by control of the driver electronics 2007 based on the selection control signal from the controller 6001, at appropriate depths of focus according to the selected viewing mode, e.g., the viewing mode for which the display content is optimized. As noted above, the blurring of the portions of the display area according to the selected viewing mode mimics the optical cues for the eyes provided when viewing real 3D objects, thereby allowing the viewer to see the stereo display in focus without unnaturally decoupling the linked processes of accommodation and convergence.

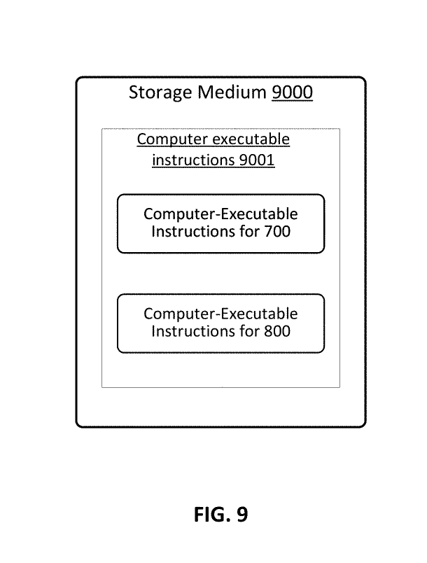

FIG. 9 illustrates an embodiment of a storage medium 9000. The storage medium 9000 may comprise an article of manufacture. In some examples, the storage medium 9000 may include any non-transitory computer readable medium or machine readable medium, such as an optical, magnetic or semiconductor storage. The storage medium 9000 may store various types of computer executable instructions e.g., 9001. For example, the storage medium 9000 may store various types of computer executable instructions to implement technique 700. For example, the storage medium 9000 may store various types of computer executable instructions to implement technique 800.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

In some embodiments, the control architecture 600 shown in FIG. 6 may comprise or be implemented as part of a computing device or a platform suitable for use in conjunction with implementation of one or more of logic flow 700 and logic flow 800. The embodiments are not limited in this context.

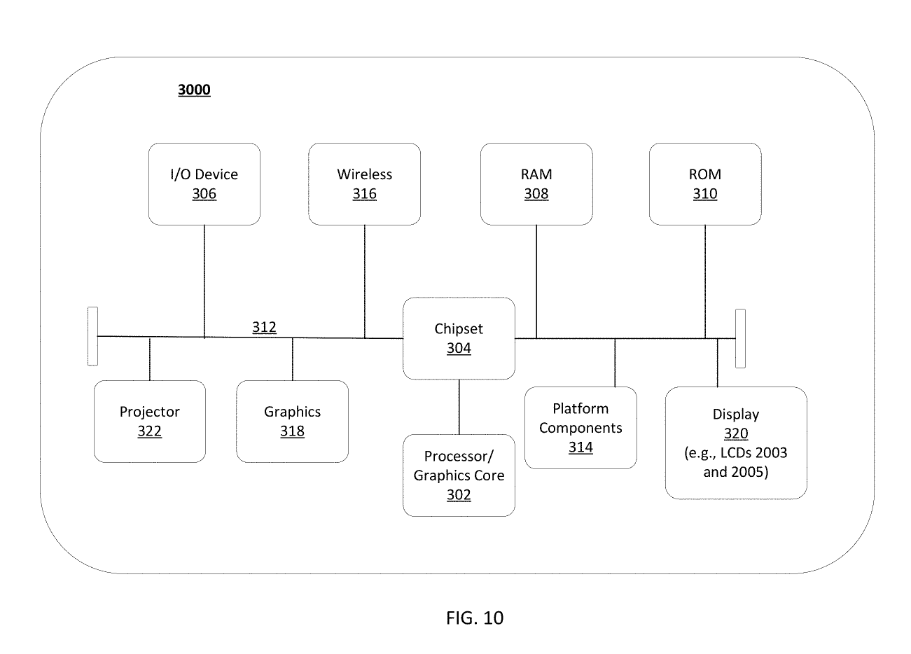

FIG. 10 is a diagram of an exemplary system embodiment and in particular, depicts a platform 3000, which platform may be suitable for use in conjunction with implementation of one or more of logic flow 700, logic flow 800, driver electronics 2007, and controller 6001. FIG. 10 depicts that platform (system) 3000 may include a processor/graphics core 302, a chipset 304, an input/output (I/O) device 306, a random access memory (RAM) (such as dynamic RAM (DRAM)) 308, and a read only memory (ROM) 310, display electronics 320 (e.g., LCD 2003, LCD 2005, or the like), projector 322 (e.g., backlight 2006, or the like), and various other platform components 314 (e.g., a fan, a cross flow blower, a heat sink, DTM system, cooling system, housing, vents, and so forth). Platform (system) 3000 may also include wireless communications chip 316 and graphics device 318. The embodiments, however, are not limited to these elements.

As depicted, I/O device 306, RAM 308, and ROM 310 are coupled to processor 302 by way of chipset 304. Chipset 304 may be coupled to processor 302 by a bus 312. Accordingly, bus 312 may include multiple lines.

Processor 302 may be a central processing unit comprising one or more processor cores and may include any number of processors having any number of processor cores. The processor 302 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 302 may be multiple separate processors located on separate integrated circuit chips. In some embodiments processor 302 may be a processor having integrated graphics, while in other embodiments processor 302 may be a graphics core or cores.

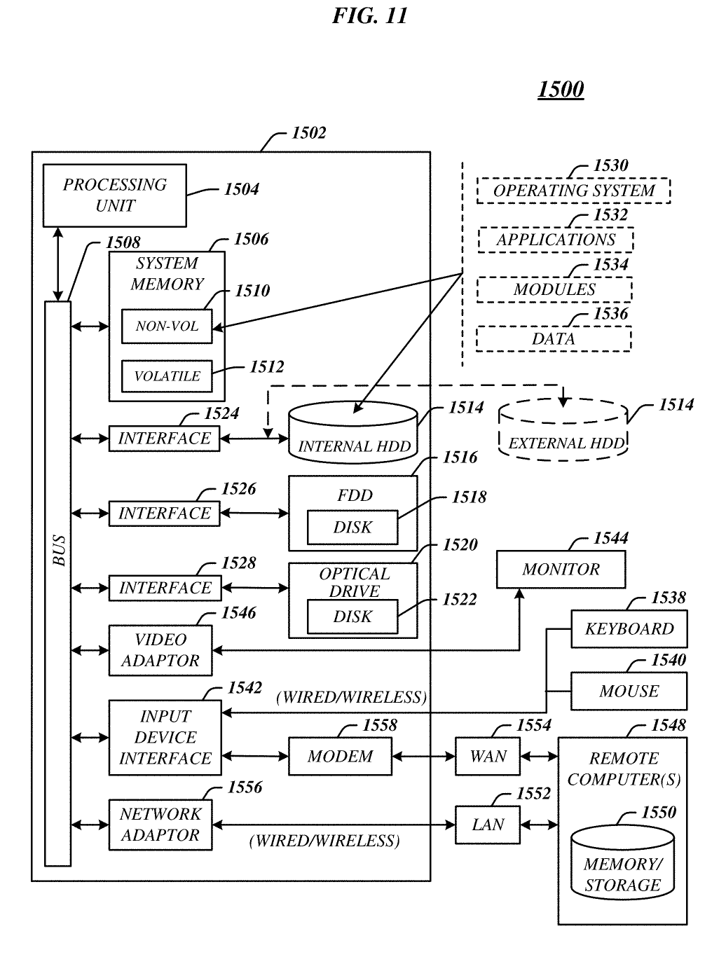

FIG. 11 illustrates an embodiment of an exemplary computing architecture 1500 that may be suitable for implementing various embodiments as previously described. In various embodiments, the computing architecture 1500 may comprise or be implemented as part of an electronic device, e.g., the HMD 200. In some embodiments, the computing architecture 1500 may be representative, for example, of a computing device suitable for use in conjunction with implementation of one or more of logic flow 700, logic flow 800, driver electronics 2007, and controller 6001. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1500.

As shown in FIG. 11, according to computing architecture 1500, a computer 1502 comprises a processing unit 1504, a system memory 1506 and a system bus 1508. In some embodiments, computer 1502 may comprise a server. In some embodiments, computer 1502 may comprise a client. The processing unit 1504 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1504.

The system bus 1508 provides an interface for system components including, but not limited to, the system memory 1506 to the processing unit 1504. The system bus 1508 can be any of several types of bus structure that may further interconnect to a memory bus (with or without a memory controller), a peripheral bus, and a local bus using any of a variety of commercially available bus architectures. Interface adapters may connect to the system bus 1508 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1506 can include non-volatile memory 1510 and/or volatile memory 1512. A basic input/output system (BIOS) can be stored in the non-volatile memory 1510.

The computer 1502 may include various types of computer-readable storage media in the form of one or more lower speed memory units, including an internal (or external) hard disk drive (HDD) 1514, a magnetic floppy disk drive (FDD) 1516 to read from or write to a removable magnetic disk 1518, and an optical disk drive 1520 to read from or write to a removable optical disk 1522 (e.g., a CD-ROM or DVD). The HDD 1514, FDD 1516 and optical disk drive 1520 can be connected to the system bus 1508 by a HDD interface 1524, an FDD interface 1526 and an optical drive interface 1528, respectively. The HDD interface 1524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1510, 1512, including an operating system 1530, one or more application programs 1532, other program modules 1534, and program data 1536.

A user can enter commands and information into the computer 1502 through one or more wire/wireless input devices, for example, a keyboard 1538 and a pointing device, such as a mouse 1540. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1504 through an input device interface 1542 that is coupled to the system bus 1508, but can be connected by other interfaces such as a parallel port, IEEE 1394 serial port, a game port, a USB port, an IR interface, and so forth.

A monitor 1544 or other type of display device is also connected to the system bus 1508 via an interface, such as a video adaptor 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer 1548. The remote computer 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wire/wireless connectivity to a local area network (LAN) 1552 and/or larger networks, for example, a wide area network (WAN) 1554. Such LAN and WAN networking environments are commonplace in offices and companies, and facilitate enterprise-wide computer networks, such as intranets, all of which may connect to a global communications network, for example, the Internet.

When used in a LAN networking environment, the computer 1502 is connected to the LAN 1552 through a wire and/or wireless communication network interface or adaptor 1556. The adaptor 1556 can facilitate wire and/or wireless communications to the LAN 1552, which may also include a wireless access point disposed thereon for communicating with the wireless functionality of the adaptor 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wire and/or wireless device, connects to the system bus 1508 via the input device interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

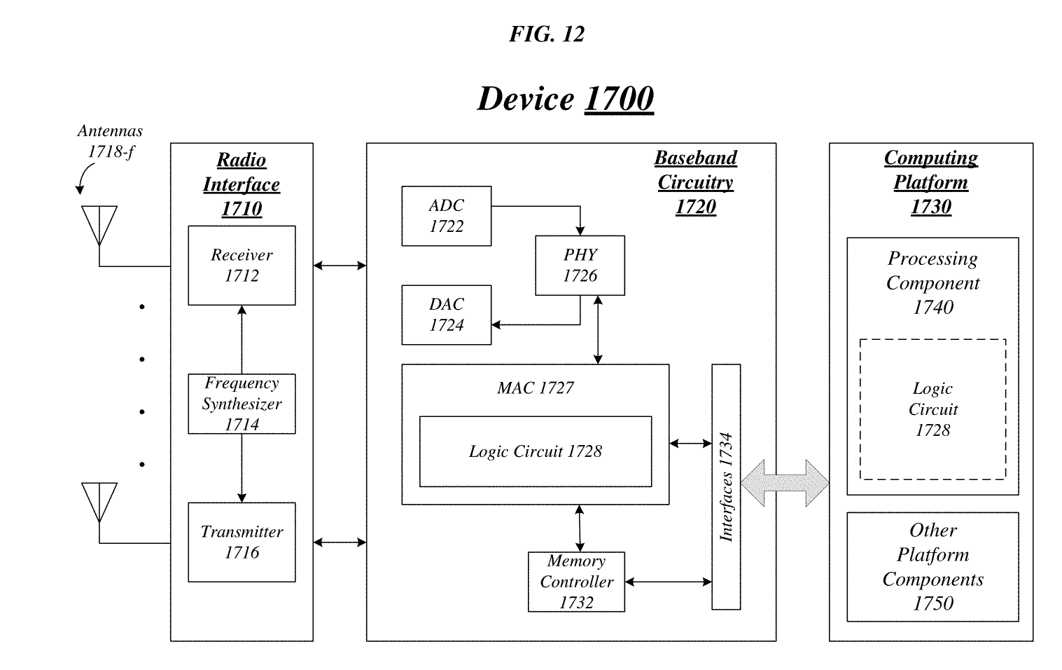

FIG. 12 illustrates an embodiment of a communications device 1700 that may implement one or more of logic flow 700, logic flow 800, driver electronics 2007, controller 6001, memory 6002, storage medium 9000, and computing architecture 1500 according to some embodiments. In various embodiments, device 1700 may comprise a logic circuit 1728. The logic circuit 1728 may include physical circuits to perform operations described for one or more of logic flow 700 and logic flow 800, for example. As shown in FIG. 12, device 1700 may include a radio interface 1710, baseband circuitry 1720, and computing platform 1730, although the embodiments are not limited to this configuration.

The device 1700 may implement some or all of the structure and/or operations for one or more of logic flow 700, logic flow 800, driver electronics 2007, controller 6001, memory 6002, storage medium 9000, computing architecture 1500, and logic circuit 1728 in a single computing entity, such as entirely within a single device. Alternatively, the device 1700 may distribute portions of the structure and/or operations for one or more of logic flow 700, logic flow 800, driver electronics 2007, controller 6001, memory 6002, storage medium 9000, computing architecture 1500, and logic circuit 1728 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1710 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 1710 may include, for example, a receiver 1712, a frequency synthesizer 1714, and/or a transmitter 1716. Radio interface 1710 may include bias controls, a crystal oscillator and/or one or more antennas 1718-f. In another embodiment, radio interface 1710 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1720 may communicate with radio interface 1710 to process receive and/or transmit signals and may include, for example, a mixer for down-converting received RF signals, an analog-to-digital converter 1722 for converting analog signals to digital form, a digital-to-analog converter 1724 for converting digital signals to analog form, and a mixer for up-converting signals for transmission. Further, baseband circuitry 1720 may include a baseband or physical layer (PHY) processing circuit 1726 for PHY link layer processing of respective receive/transmit signals. Baseband circuitry 1720 may include, for example, a medium access control (MAC) processing circuit 1727 for MAC/data link layer processing. Baseband circuitry 1720 may include a memory controller 1732 for communicating with MAC processing circuit 1727 and/or a computing platform 1730, for example, via one or more interfaces 1734.

In some embodiments, PHY processing circuit 1726 may include a frame construction and/or detection module, in combination with additional circuitry such as a buffer memory, to construct and/or deconstruct communication frames. Alternatively, or in addition, MAC processing circuit 1727 may share processing for certain of these functions or perform these processes independent of PHY processing circuit 1726. In some embodiments, MAC and PHY processing may be integrated into a single circuit.

The computing platform 1730 may provide computing functionality for the device 1700. As shown, the computing platform 1730 may include a processing component 1740. In addition to, or alternatively of, the baseband circuitry 1720, the device 1700 may execute processing operations or logic for one or more of logic flow 700, logic flow 800, driver electronics 2007, controller 6001, memory 6002, storage medium 9000, computing architecture 1500, and logic circuit 1728 using the processing component 1740. The processing component 1740 (and/or PHY 1726 and/or MAC 1727) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1730 may further include other platform components 1750. Other platform components 1750 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1700 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 1700 described herein, may be included or omitted in various embodiments of device 1700, as suitably desired.

Embodiments of device 1700 may be implemented using single input single output (SISO) architectures. However, certain implementations may include multiple antennas (e.g., antennas 1718-f) for transmission and/or reception using adaptive antenna techniques for beamforming or spatial division multiple access (SDMA) and/or using MIMO communication techniques.

The components and features of device 1700 may be implemented using any combination of discrete circuitry, application specific integrated circuits (ASICs), logic gates and/or single chip architectures. Further, the features of device 1700 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1700 shown in the block diagram of FIG. 12 may represent one functionally descriptive example of many potential implementations. Accordingly, division, omission or inclusion of block functions depicted in the accompanying figures does not infer that the hardware components, circuits, software and/or elements for implementing these functions would be necessarily divided, omitted, or included in embodiments.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

### Example 1

An apparatus, comprising: at least one optical assembly to present a stereoscopic image display on at least one display element, the at least one optical assembly comprising at least one optical element and having an adjustable depth of focus; and a controller to generate a control signal to cause the at least one optical assembly to adjust the depth of focus of the at least one optical assembly to be in one of at least two different viewing modes having different depths of focus.

### Example 2

The apparatus of Example 1, the controller to generate the control signal based on a determination of whether the stereoscopic image display is optimized for one of the at least two different viewing modes, the control signal to cause adjustment of the depth of focus of the at least one optical assembly to be in the viewing mode corresponding to the determined viewing mode for which the stereoscopic image display is optimized.

### Example 3

The apparatus of Example 1, the controller to generate the control signal based on a switching signal for selecting one of the at least two different viewing modes of the at least one optical assembly, the at least two different viewing modes having different depths of focus, the control signal to cause adjustment of the depth of focus of the at least one optical assembly to correspond to the selected viewing mode of the at least one optical assembly.

### Example 4

The apparatus of Example 2, the at least one optical assembly comprising at least two optical subassemblies, each optical subassembly comprising an optical element and an actuator element to adjust the depth of focus of the optical element.

### Example 5

The apparatus of Example 4, the actuator element comprising one of (i) a piezo-actuator element to adjust the shape of the optical element to adjust the depth of focus of the optical element, or (ii) a voice coil motor (VCM) to adjust the depth of focus of the optical element.

### Example 6

The apparatus of Example 4, the controller to blur a portion of the stereoscopic image display on the at least one display element depending on the determined viewing mode.

### Example 7

The apparatus of Example 3, the at least one optical assembly comprising at least two optical subassemblies, each optical subassembly comprising an optical element and an actuator element to adjust the depth of focus of the optical element.

### Example 8

The apparatus of Example 7, the actuator element comprising one of (i) a piezo-actuator element to adjust the shape of the optical element to adjust the depth of focus of the optical element, or (ii) a voice coil motor (VCM) to adjust the depth of focus of the optical element.

### Example 9

The apparatus of Example 7, the controller to blur a portion of the stereoscopic image display on the at least one display element depending on the selected viewing mode.

### Example 10

The apparatus of Example 3, comprising: a switching element to generate the switching signal.

### Example 11

The apparatus of Example 3, the controller to receive the switching signal from an external device.

### Example 12

A system comprising: at least one memory element; and an apparatus comprising: at least two optical subassemblies to present a stereoscopic image display on the at least one display element, each optical subassembly comprising an optical element and an actuator element to adjust the depth of focus of the optical element; and a controller to generate a control signal to cause the at least two optical subassemblies to adjust the depth of focus of the at least two optical subassemblies to be in one of at least two different viewing modes having different depths of focus.

### Example 13

The system of Example 12, the controller to generate the control signal based on a determination of whether the stereoscopic image display is optimized for one of the at least two different viewing modes, the control signal to cause adjustment of the depth of focus of the at least two optical subassemblies to be in the viewing mode corresponding to the determined viewing mode for which the stereoscopic image display is optimized.

### Example 14

The system of Example 13, the controller to blur a portion of the stereoscopic image display on the at least one display element depending on the determined viewing mode.

### Example 15

The system of Example 12, the controller to generate the control signal based on a switching signal for selecting one of the at least two different viewing modes of the at least two optical subassemblies, the at least two different viewing modes having different depths of focus, the control signal to cause adjustment of the depth of focus of the at least two optical subassemblies to correspond to the selected viewing mode of the at least two optical subassemblies.

### Example 16

The system of Example 15, the controller to blur a portion of the stereoscopic image display on the at least one display element depending on the selected viewing mode.

### Example 17

The system of Example 16, comprising: a switching element to generate the switching signal.

### Example 18

A method comprising: displaying a stereoscopic image on at least one display element; and controlling at least one optical assembly to present the stereoscopic image, the controlling comprising generating a control signal to cause the at least one optical assembly to adjust the depth of focus of the at least one optical assembly to be in one of at least two different viewing modes having different depths of focus.

### Example 19

The method of Example 18, comprising: determining whether the stereoscopic image display is optimized for one of the at least two different viewing modes; and generating the control signal to cause adjustment of the depth of focus of the at least one optical assembly to be in the viewing mode corresponding to the determined viewing mode for which the stereoscopic image display is optimized.

### Example 20

The method of Example 19, comprising: blurring a portion of the stereoscopic image display on the at least one display element depending on the determined viewing mode; the at least one optical assembly comprising at least two optical subassemblies, each optical subassembly comprising an optical element and an actuator element to adjust the depth of focus of the optical element.

### Example 22

The method of Example 18, comprising: generating the control signal based on a switching signal for selecting one of the at least two different viewing modes of the at least one optical assembly, the at least two different viewing modes having different depths of focus, the control signal to cause adjustment of the depth of focus of the at least one optical assembly to correspond to the selected viewing mode of the at least one optical assembly.

### Example 23

The method of Example 22, the at least one optical assembly comprising at least two optical subassemblies, each optical subassembly comprising an optical element and an actuator element to adjust the depth of focus of the optical element, and the actuator element comprising one of (i) a piezo-actuator element to adjust the shape of the optical element to adjust the depth of focus of the optical element, or (ii) a voice coil motor (VCM) to adjust the depth of focus of the optical element.

### Example 24

The method of Example 22, comprising: blurring a portion of the stereoscopic image display on the at least one display element depending on the selected viewing mode; the at least one optical assembly comprising at least two optical subassemblies, each optical subassembly comprising an optical element and an actuator element to adjust the depth of focus of the optical element.

### Example 25

The method of Example 22, comprising: receiving the switching signal from a switching element.

### Example 26

The method of Example 18, the at least one optical assembly comprising an optical element, the optical element comprising a polymer layer.

### Example 27

The method of Example 18, the at least one optical assembly comprising at least two optical subassemblies, each optical subassembly comprising an optical element, the optical element comprising a polymer layer.

### Example 28

The method of Example 27, each optical subassembly comprising an actuator element to adjust the depth of focus of the optical element.

### Example 29

The method of Example 20, the optical element comprising a polymer layer.

### Example 30

The method of Example 18, the at least one optical assembly comprising an optical element, the optical element comprising at least two lenses.

### Example 31

The method of Example 18, the at least one optical assembly comprising at least two optical subassemblies, each optical subassembly comprising an optical element, the optical element comprising at least two lenses.

### Example 32

The method of Example 31, each optical subassembly comprising an actuator element to adjust the depth of focus of the optical element by adjusting the spacing between the at least two lenses.

### Example 33

The method of Example 21, the optical element comprising at least two lenses, the actuator element to adjust the depth of focus of the optical element by adjusting the spacing between the at least two lenses.

### Example 34

The apparatus of Example 4, the optical element comprising a polymer layer.

### Example 35

The apparatus of Example 34, the actuator element comprising a piezo-actuator element to adjust the shape of the optical element to adjust the depth of focus of the optical element.

### Example 36

The apparatus of Example 4, the optical element comprising at least two lenses.

### Example 37

The apparatus of Example 36, the actuator element comprising a voice coil motor (VCM) to adjust the depth of focus of the optical element by adjusting the spacing between the at least two lenses.

### Example 38

The apparatus of Example 7, the optical element comprising a polymer layer.

### Example 39

The apparatus of Example 38, the actuator element comprising a piezo-actuator element to adjust the shape of the optical element to adjust the depth of focus of the optical element.

### Example 40

The apparatus of Example 7, the optical element comprising at least two lenses.

### Example 41

The apparatus of Example 40, the actuator element comprising a voice coil motor (VCM) to adjust the depth of focus of the optical element.

### Example 42

The apparatus of Example 7, comprising: a switching element to generate the switching signal.

### Example 43

The apparatus of Example 8, comprising: a switching element to generate the switching signal.

### Example 44

The apparatus of Example 9, comprising: a switching element to generate the switching signal.

### Example 45

The apparatus of Example 7, the controller to receive the switching signal from an external device.

### Example 46

The apparatus of Example 8, the controller to receive the switching signal from an external device.

### Example 47

The apparatus of Example 9, the controller to receive the switching signal from an external device.

### Example 48

The system of Example 13, the actuator element comprising one of (i) a piezo-actuator element to adjust the shape of the optical element to adjust the depth of focus of the optical element, or (ii) a voice coil motor (VCM) to adjust the depth of focus of the optical element.

### Example 49

The system of Example 13, one of: (i) the optical element comprising a polymer layer; or (ii) the optical element comprising at least two lenses.

### Example 50

The system of Example 15, the actuator element comprising one of (i) a piezo-actuator element to adjust the shape of the optical element to adjust the depth of focus of the optical element, or (ii) a voice coil motor (VCM) to adjust the depth of focus of the optical element.

### Example 51

The system of Example 15, one of: (i) the optical element comprising a polymer layer; or (ii) the optical element comprising at least two lenses.

### Example 52

At least one non-transitory machine-readable storage medium comprising instructions that, when executed by a processor element, cause the processor element to: display a stereoscopic image on at least one display element; and control at least one optical assembly to present the stereoscopic image, the control comprising generating a control signal to cause the at least one optical assembly to adjust the depth of focus of the at least one optical assembly to be in one of at least two different viewing modes having different depths of focus.

### Example 53

The at least one non-transitory machine-readable storage medium of Example 52, comprising instructions that, when executed by a processor element, cause the processor element to: determine whether the stereoscopic image display is optimized for one of the at least two different viewing modes; and generate the control signal to cause adjustment of the depth of focus of the at least one optical assembly to be in the viewing mode corresponding to the determined viewing mode for which the stereoscopic image display is optimized.

### Example 54

The at least one non-transitory machine-readable storage medium of Example 53, comprising instructions that, when executed by a processor element, cause the processor element to: blur a portion of the stereoscopic image display on the at least one display element depending on the determined viewing mode; the at least one optical assembly comprising at least two optical subassemblies, each optical subassembly comprising an optical element and an actuator element to adjust the depth of focus of the optical element.

### Example 55

The at least one non-transitory machine-readable storage medium of Example 53, the at least one optical assembly comprising at least two optical subassemblies, each optical subassembly comprising an optical element and an actuator element to adjust the depth of focus of the optical element, and the actuator element comprising one of (i) a piezo-actuator element to adjust the shape of the optical element to adjust the depth of focus of the optical element, or (ii) a voice coil motor (VCM) to adjust the depth of focus of the optical element.

### Example 56

The at least one non-transitory machine-readable storage medium of Example 55, one of: (i) the optical element comprising a polymer layer; or (ii) the optical element comprising at least two lenses.

### Example 57

The at least one non-transitory machine-readable storage medium of Example 52, comprising instructions that, when executed by a processor element, cause the processor element to: generate the control signal based on a switching signal for selecting one of the at least two different viewing modes of the at least one optical assembly, the at least two different viewing modes having different depths of focus, the control signal to cause adjustment of the depth of focus of the at least one optical assembly to correspond to the selected viewing mode of the at least one optical assembly.

### Example 58

The at least one non-transitory machine-readable storage medium of Example 57, comprising instructions that, when executed by a processor element, cause the processor element to: blur a portion of the stereoscopic image display on the at least one display element depending on the selected viewing mode; the at least one optical assembly comprising at least two optical subassemblies, each optical subassembly comprising an optical element and an actuator element to adjust the depth of focus of the optical element.

### Example 59

The at least one non-transitory machine-readable storage medium of Example 57, the at least one optical assembly comprising at least two optical subassemblies, each optical subassembly comprising an optical element and an actuator element to adjust the depth of focus of the optical element, and the actuator element comprising one of (i) a piezo-actuator element to adjust the shape of the optical element to adjust the depth of focus of the optical element, or (ii) a voice coil motor (VCM) to adjust the depth of focus of the optical element.

### Example 60

The at least one non-transitory machine-readable storage medium of Example 59, one of: (i) the optical element comprising a polymer layer; or (ii) the optical element comprising at least two lenses.

### Example 61

The at least one non-transitory machine-readable storage medium of Example 57, comprising instructions that, when executed by a processor element, cause the processor element to: receive the switching signal from a switching element.

### Example 62

The at least one non-transitory machine-readable storage medium of Example 52, the at least one optical assembly comprising an optical element, the optical element comprising a polymer layer.

1. An apparatus, comprising:
at least one optical assembly to present a stereoscopic image display on at least one display element, the at least one optical assembly comprising at least one optical element and having an adjustable depth of focus; and
a controller to generate a control signal to cause the at least one optical assembly to adjust the depth of focus of the at least one optical assembly to be in one of at least two different viewing modes having different depths of focus.

2. The apparatus of claim 1, the controller to generate the control signal based on a determination of whether the stereoscopic image display is optimized for one of the at least two different viewing modes, the control signal to cause adjustment of the depth of focus of the at least one optical assembly to be in the viewing mode corresponding to the determined viewing mode for which the stereoscopic image display is optimized.

3. The apparatus of claim 1, the controller to generate the control signal based on a switching signal for selecting one of the at least two different viewing modes of the at least one optical assembly, the at least two different viewing modes having different depths of focus, the control signal to cause adjustment of the depth of focus of the at least one optical assembly to correspond to the selected viewing mode of the at least one optical assembly.

4. The apparatus of claim 2, the at least one optical assembly comprising at least two optical subassemblies, each optical subassembly comprising an optical element and an actuator element to adjust the depth of focus of the optical element.

5. The apparatus of claim 4, the actuator element comprising one of (i) a piezo-actuator element to adjust the shape of the optical element to adjust the depth of focus of the optical element, or (ii) a voice coil motor (VCM) to adjust the depth of focus of the optical element.

6. The apparatus of claim 4, the controller to blur a portion of the stereoscopic image display on the at least one display element depending on the determined viewing mode.

7. The apparatus of claim 3, the at least one optical assembly comprising at least two optical subassemblies, each optical subassembly comprising an optical element and an actuator element to adjust the depth of focus of the optical element.

8. The apparatus of claim 7, the actuator element comprising one of (i) a piezo-actuator element to adjust the shape of the optical element to adjust the depth of focus of the optical element, or (ii) a voice coil motor (VCM) to adjust the depth of focus of the optical element.

9. The apparatus of claim 7, the controller to blur a portion of the stereoscopic image display on the at least one display element depending on the selected viewing mode.

10. (canceled)

11. The apparatus of claim 3, the controller to receive the switching signal from an external device.

12. A system comprising:
at least one memory element; and
an apparatus comprising:
at least two optical subassemblies to present a stereoscopic image display on at least one display element, each optical subassembly comprising an optical element and an actuator element to adjust the depth of focus of the optical element; and
a controller to generate a control signal to cause the at least two optical subassemblies to adjust the depth of focus of the at least two optical subassemblies to be in one of at least two different viewing modes having different depths of focus.

13. The system of claim 12, the controller to generate the control signal based on a determination of whether the stereoscopic image display is optimized for one of the at least two different viewing modes, the control signal to cause adjustment of the depth of focus of the at least two optical subassemblies to be in the viewing mode corresponding to the determined viewing mode for which the stereoscopic image display is optimized.

14. The system of claim 13, the controller to blur a portion of the stereoscopic image display on the at least one display element depending on the determined viewing mode.

15. The system of claim 12, the controller to generate the control signal based on a switching signal for selecting one of the at least two different viewing modes of the at least two optical subassemblies, the at least two different viewing modes having different depths of focus, the control signal to cause adjustment of the depth of focus of the at least two optical subassemblies to correspond to the selected viewing mode of the at least two optical subassemblies.

16. The system of claim 15, the controller to blur a portion of the stereoscopic image display on the at least one display element depending on the selected viewing mode.

17. (canceled)

18. A method comprising:
displaying a stereoscopic image on at least one display element; and
controlling at least one optical assembly to present the stereoscopic image, the controlling comprising generating a control signal to cause the at least one optical assembly to adjust the depth of focus of the at least one optical assembly to be in one of at least two different viewing modes having different depths of focus.

19. The method of claim 18, comprising:
determining whether the stereoscopic image display is optimized for one of the at least two different viewing modes; and
generating the control signal to cause adjustment of the depth of focus of the at least one optical assembly to be in the viewing mode corresponding to the determined viewing mode for which the stereoscopic image display is optimized.

20. The method of claim 19, comprising:
blurring a portion of the stereoscopic image display on the at least one display element depending on the determined viewing mode;
the at least one optical assembly comprising at least two optical subassemblies, each optical subassembly comprising an optical element and an actuator element to adjust the depth of focus of the optical element.

21. The method of claim 19, the at least one optical assembly comprising at least two optical subassemblies, each optical subassembly comprising an optical element and an actuator element to adjust the depth of focus of the optical element, and the actuator element comprising one of (i) a piezo-actuator element to adjust the shape of the optical element to adjust the depth of focus of the optical element, or (ii) a voice coil motor (VCM) to adjust the depth of focus of the optical element.

22. The method of claim 18, comprising:
generating the control signal based on a switching signal for selecting one of the at least two different viewing modes of the at least one optical assembly, the at least two different viewing modes having different depths of focus, the control signal to cause adjustment of the depth of focus of the at least one optical assembly to correspond to the selected viewing mode of the at least one optical assembly.

23. The method of claim 22, the at least one optical assembly comprising at least two optical subassemblies, each optical subassembly comprising an optical element and an actuator element to adjust the depth of focus of the optical element, and the actuator element comprising one of (i) a piezo-actuator element to adjust the shape of the optical element to adjust the depth of focus of the optical element, or (ii) a voice coil motor (VCM) to adjust the depth of focus of the optical element.

24. The method of claim 22, comprising:
blurring a portion of the stereoscopic image display on the at least one display element depending on the selected viewing mode;
the at least one optical assembly comprising at least two optical subassemblies, each optical subassembly comprising an optical element and an actuator element to adjust the depth of focus of the optical element.

25. The method of claim 22, comprising:
receiving the switching signal from a switching element.
